(19) United States
(12) Patent Application Publication
(10) Pub. No.: US 2026/0145476 A1
(43) Pub. Date: May 28, 2026

(54) ELECTRIC VEHICLE LOAD LEVELING SYSTEMS AND METHODS

(71) Applicant: American EV, LLC, Jacksonville, FL (US)

(72) Inventors: Aric Singletary, Yulee, FL (US); Ryan Nixon, Austin, TX (US); Tim Giese, White Bear Lake, MN (US); Ryan Baskerville, Atlantic Beach, FL (US); Jessica Butler, Callahan, FL (US)

(21) Appl. No.: 19/396,951

(22) Filed: Nov. 21, 2025

Related U.S. Application Data
(60) Provisional application No. 63/723,933, filed on Nov. 22, 2024.

(51) Int. Cl. B60G 17/015; B60G 17/019

(52) U.S. Cl. CPC B60G 17/0155; B60G 17/019; B60G 2202/152; B60G 2300/50; B60G 2400/252; B60G 2500/201

(57) ABSTRACT

An electric vehicle may be equipped with an adaptive suspension system that includes a chassis, a suspension system coupled to the chassis, and at least one helper spring configured to assist the suspension system. The vehicle may include at least one sensor configured to measure suspension travel, including vertical displacement between the vehicle's wheels and body. A controller, coupled to the helper spring and the sensor, may adjust the stiffness of the helper spring based on the measured travel. The stiffness of the helper spring may be varied in response to changes in load, such as added or removed weight, to improve ride quality, stability, and handling. The system may further include multiple helper springs, a user interface for manual adjustment, and an automatic adjustment feature based on the suspension's measured travel.

### CROSS-REFERENCES TO RELATED APPLICATIONS

This application claims priority to U.S. Provisional Patent Application Ser. No. 63/723,933 filed Nov. 22, 2024, the entirety of which is incorporated by reference herein.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### BACKGROUND

The present disclosure relates generally to electrical vehicle systems and/or accessories. More particularly, the present disclosure pertains to an electrical vehicle with load leveling systems.

The increasing demand for specialized vehicles such as utility task vehicles (UTVs), low-speed vehicles (LSVs), lightweight electric vehicles (LEVs), medium-speed vehicles (MSVs), and neighborhood electric vehicles (NEVs) underscores the evolving needs of consumers and industries alike. These vehicles are essential for a variety of applications, from recreational off-roading to practical tasks in agriculture, construction, and urban transportation. Despite their popularity, many of these vehicles remain reliant on internal combustion engines, which pose significant environmental challenges, including air pollution and greenhouse gas emissions.

In recent years, the electric vehicle (EV) market has experienced substantial growth, driven by technological advancements and a societal shift towards sustainability. Electric powertrains offer numerous benefits, such as lower operational costs, reduced noise, and zero tailpipe emissions. Modern electric vehicles are designed with an emphasis on efficiency, power economy (e.g., battery range), and overall performance. However, existing electric alternatives in the UTV, LSV, LEV, MSV, and NEV categories often face critical limitations. The reduced weight of these vehicles, while advantageous for power efficiency, introduces challenges, particularly in the management of the vehicle's suspension system and cargo carrying capacity.

The suspension system in a vehicle may be responsible for supporting items such as the vehicle's weight (e.g., when unloaded and loaded), absorbing shocks from the road, and ensuring the tires maintain optimal contact with the road surface. In heavier vehicles, the suspension system may be generally more robust and better equipped to handle varying loads without significantly affecting ride quality or stability. However, in lightweight vehicles, even what would typically be considered a small or insignificant load can have disproportionately large effects on the suspension system.

Due to the reduced overall mass, the suspension components in these lightweight vehicles are more sensitive to changes in load. As a result, even minor variations in load—such as a slight shift in weight from a single passenger or the addition of a small cargo item—can lead to noticeable impacts on ride quality, handling, and vehicle dynamics. These effects may include excessive body roll, instability during cornering, and poor ride comfort, which can negatively affect the overall driving experience and safety.

Existing suspension systems may not be adequately designed to handle such small yet significant load changes, especially in lightweight vehicles. This has created a need for improved suspension solutions that can efficiently adapt to varying loads, minimizing their impact on the vehicle's stability, handling, and comfort without compromising overall performance.

### BRIEF SUMMARY

In view of at least some of the above-referenced problems with conventional UTVs, LSVs, LEVs, MSVs, NEVs, and similar vehicles, an exemplary object of the present disclosure may be to provide a new and improved electric vehicle having a load leveling system which works in conjunction with the electric vehicle's standard suspension system.

An exemplary electric vehicle may desirably feature one or more helper springs configured to adjust the ride height and suspension rate due to a shift in weight onto the rear wheels of the electric vehicle. In other optional embodiments, the one or more helper springs may be applied to a front portion of the suspension system to make similar adjustments when necessary. The exemplary such electric vehicle may further feature automatic control of the one or more helper springs. In other optional embodiments, the exemplary such electric vehicle may feature manual control of the one or more helper springs.

In a particular embodiment, an exemplary electric vehicle as disclosed herein may include a chassis, a suspension system, at least one helper spring, at least one sensor, and a controller. The suspension system may be coupled to the chassis. The at least one helper spring may be coupled to and configured to selectively assist the suspension system. The at least one sensor may be configured to measure an amount of travel of at least part of the suspension system. The controller may be coupled to the at least one helper spring and the at least one sensor. The controller may be configured to control a stiffness of the at least one helper spring based on the measured amount of travel of the at least part of the suspension system.

In an exemplary aspect according to the above-referenced embodiment, the amount of travel of the suspension system may be associated with a vertical distance between one or more of a plurality of wheels of the electric vehicle and a vehicle body of the electric vehicle.

In another exemplary aspect according to the above-referenced embodiment, the at least one helper spring may be configured to provide a first stiffness. The first stiffness may be associated with a first amount of travel measured by the at least one sensor, and the first amount of travel may be associated with a first weight acting on the electric vehicle. The at least one helper spring may further be configured to provide a second stiffness. The second stiffness may be associated with a second amount of travel measured by the at least one sensor, and the second amount of travel may be associated with a second weight acting on the electric vehicle.

In another exemplary aspect according to the above-referenced embodiment, the second amount of travel distance may be greater than the first amount of travel.

In another exemplary aspect according to the above-referenced embodiment, the first amount of travel may be less than a predetermined threshold amount of travel.

In another exemplary aspect according to the above-referenced embodiment, the second amount of travel may be greater than or equal to the predetermined threshold amount of travel.

In another exemplary aspect according to the above-referenced embodiment, the at least one helper spring may include a first helper spring and a second helper spring.

In another exemplary aspect according to the above-referenced embodiment, an unloaded stiffness of each of the first helper spring and the second helper spring may be matched.

In another exemplary aspect according to the above-referenced embodiment, an unloaded stiffness of each of the first helper spring and the second helper spring may be different.

In another exemplary aspect according to the above-referenced embodiment, the first helper spring may be associated with a forward portion of the suspension system and the second helper spring may be associated with a rearward portion of the suspension system.

In another exemplary aspect according to the above-referenced embodiment, the first helper spring may be a pair of helper springs associated with a forward portion of the suspension system and the second helper spring may be a pair of helper springs associated with a rearward portion of the suspension system.

In another exemplary aspect according to the above-referenced embodiment, an amount of stiffness of the at least one helper spring may be adjusted to be proportional to the measured amount of travel.

In another exemplary aspect according to the above-referenced embodiment, the electric vehicle may further include a user interface coupled to the controller. The user interface may comprise a switch configured to provide a signal to the controller indicative of a position of the switch. The controller may change the stiffness of the at least one helper spring based on the signal indicative of the position of the switch.

In another exemplary aspect according to the above-referenced embodiment, the controller may further comprise a memory and a processing unit. The memory may have instructions stored thereon. The processing unit may be coupled to the memory, wherein the processing unit executes the instructions to automatically adjust the stiffness of the at least one helper spring based on the measured amount of travel of the suspension system.

In another exemplary aspect according to the above-referenced embodiment, the suspension system may include a first side portion associated with a first wheel of the electric vehicle and a second side portion associated with a second wheel of the electric vehicle.

In another exemplary aspect according to the above-referenced embodiment, the at least one helper spring may include a first helper spring associated with the first side portion of the suspension system and a second helper spring associated with the second side portion of the suspension system.

In another exemplary aspect according to the above-referenced embodiment, the at least one helper spring may comprise a single helper spring positioned between and coupled to the first side portion and the second side portion of the suspension system.

In another exemplary aspect according to the above-referenced embodiment, the single helper spring may be supported by a carriage coupled to each of the first side portion and the second side portion of the suspension system. In certain optional embodiments, the carriage may comprise a bell crank style suspension linkage.

In another exemplary aspect according to the above-referenced embodiment, when a vehicle body of the electric vehicle is higher than an unloaded threshold, the stiffness of the at least one helper spring may be reduced.

In another embodiment, a method of dynamically adjusting a suspension helper spring of an electric vehicle having a chassis and a main suspension system coupled to the chassis as disclosed herein may include determining an amount of travel of the main suspension system using at least one sensor, and adjusting a stiffness state of at least one suspension helper spring when the amount of travel is greater than a predetermined threshold amount of travel.

In another exemplary aspect according to the above-referenced embodiment, the method may further include providing a first stiffness may be associated with a first amount of travel sensed by the at least one sensor, the first amount of traveling being associated with a first weight added to the electric vehicle, and providing a second stiffness may be associated with a second amount of travel sensed by the at least one sensor, the second amount of traveling being associated with a second weight added to the electric vehicle.

In another exemplary aspect according to the above-referenced embodiment, the method may further include mitigating a deflection of one or more components of the main suspension system and a vehicle body of the electric vehicle due to an additional weight added to the vehicle body.

In another exemplary aspect according to the above-referenced embodiment, adjusting the stiffness state of the at least one suspension helper spring may be manually initiated.

In an exemplary aspect according to the above-referenced embodiment, adjusting the stiffness state of the at least one suspension helper spring may be automatic controlled using a controller.

### BRIEF DESCRIPTION OF THE SEVERAL VIEWS OF THE DRAWINGS

FIG. 1 is a front perspective view of an embodiment of an improved electric vehicle in accordance with the present disclosure.

FIG. 2 is a partially exploded side view of the improved electric vehicle of FIG. 1 in accordance with the present disclosure.

FIG. 3 is a side elevation view of the improved electric vehicle of FIG. 1 in accordance with the present disclosure.

FIG. 4 is a side elevation view of the improved electric vehicle of FIG. 1 with a first weight added to a rear potion of the improved electric vehicle in accordance with the present disclosure.

FIG. 5 is a side elevation view of the improved electric vehicle of FIG. 1 with a second weight added to a rear potion of the improved electric vehicle in accordance with the present disclosure.

FIG. 6 is a side elevation view of the improved electric vehicle of FIG. 1 in an unloaded and elevated configuration in accordance with the present disclosure.

FIG. 7 is an enlarged sectional view of a portion of a first embodiment of a suspension system of the improved electric vehicle of FIG. 1 in accordance with the present disclosure.

FIG. 8 is an enlarged sectional view of a portion of a second embodiment of the suspension system of the improved electric vehicle of FIG. 1 with a helper spring of the vehicle in a first operational state in accordance with the present disclosure.

FIG. 9 is an enlarged sectional view of a portion of the suspension system of the improved electric vehicle of FIG. 8 with the helper spring of the vehicle in a second operational state in accordance with the present disclosure.

FIG. 10 is a block diagram of the components of the improved electric vehicle of FIG. 1 in accordance with the present disclosure.

### DETAILED DESCRIPTION

Reference will now be made in detail to embodiments of the present disclosure, one or more drawings of which are set forth herein. Each drawing is provided by way of explanation of the present disclosure and is not a limitation. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

Thus, it is intended that the present disclosure covers such modifications and variations as come within the scope of the appended claims and their equivalents. Other objects, features, and aspects of the present disclosure are disclosed in, or are obvious from, the following detailed description. It is to be understood by one of ordinary skill in the art that the present discussion is a description of exemplary embodiments only and is not intended as limiting the broader aspects of the present disclosure.

The words “connected”, “attached”, “joined”, “mounted”, “fastened”, and the like should be interpreted to mean any manner of joining two objects including, but not limited to, the use of any fasteners such as screws, nuts and bolts, bolts, pin and clevis, and the like allowing for a stationary, translatable, or pivotable relationship; welding of any kind such as traditional MIG welding, TIG welding, friction welding, brazing, soldering, ultrasonic welding, torch welding, inductive welding, and the like; using any resin, glue, epoxy, and the like; being integrally formed as a single part together; any mechanical fit such as a friction fit, interference fit, slidable fit, rotatable fit, pivotable fit, and the like; any combination thereof; and the like.

Unless specifically stated otherwise, any part of the apparatus of the present disclosure may be made of any appropriate or suitable material including, but not limited to, metal, alloy, polymer, polymer mixture, wood, composite, or any combination thereof.

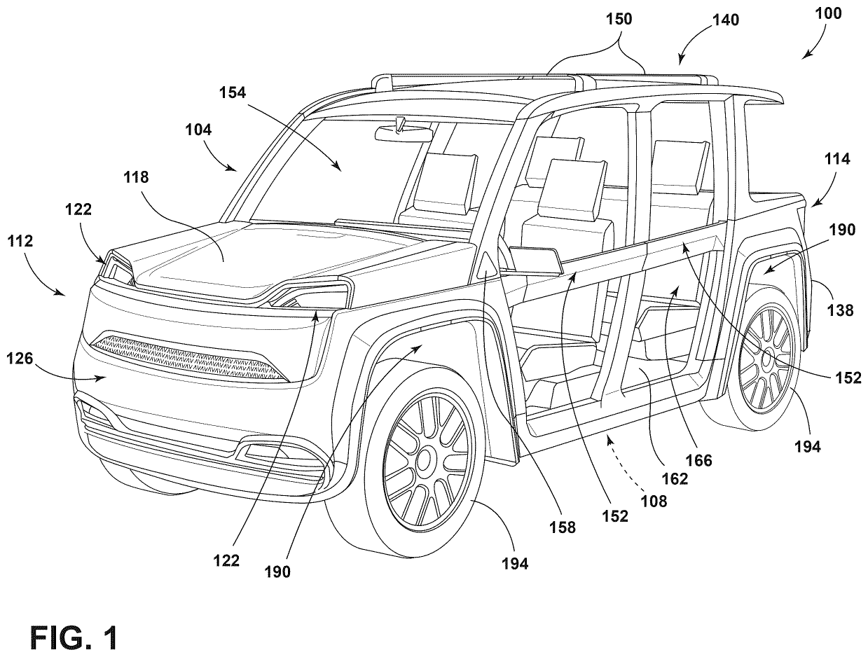

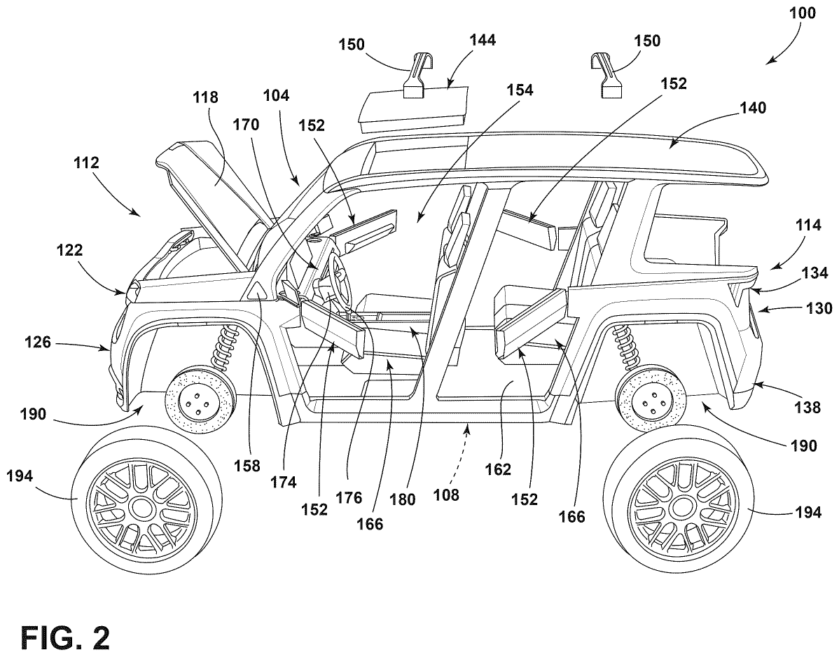

Referring to FIGS. 1-2, an exemplary improved electric vehicle 100 is shown. The electric vehicle 100 may include a vehicle body 104 coupled with a chassis 108. The chassis 108 may also be referred to herein as a frame 108. It will be understood that the electric vehicle 100 may be configured as one or more of a utility task vehicle (UTV), a low-speed vehicle (LSV), a lightweight electric vehicle (LEV), a medium-speed vehicle (MSV), and/or a neighborhood electric vehicle (NEV). In other optional embodiments, this disclosure may be applicable to other vehicles, such as internal combustion vehicles, or the like.

The body 104 may include a front portion 112 and a rear portion 114. The front portion 112 may include a front hood 118 and one or more headlight assemblies 122. The front portion 112 may further include a forward bumper 126. The rear portion 114 of the body 104 may include a tailgate assembly 130 and one or more taillight assemblies 134. The rear portion 114 may further include a rear fender 138.

The vehicle 100 may further include a roof assembly 140 extending between the front portion 112 and the rear portion 114 of the body 104. The roof assembly 140 may be operably coupled with the body 104. Alternatively, the roof assembly 140 may be integrally formed with the body 104. In various examples, the roof assembly 140 may include one or more roof panels 146 configured to at least partially form the roof of the vehicle 100. However, it will be understood that the roof assembly 140 may be a single panel or piece without departing from the scope of the present disclosure. In various examples, a roof rack and one or more rails 150 may be operably coupled with the roof assembly 140 and/or one or more of the roof panels 146.

The vehicle 100 may include one or more door assemblies 152 configured to selectively allow access to an interior 154 of the body 104. The one or more door assemblies 152 may be operably coupled with the body 104 of the vehicle and may be movable between an open position (FIG. 2) and closed position (FIG. 1). For example, the one or more door assemblies 152 may be hingedly coupled with the body 104 of the vehicle 100. The one or more door assemblies 152 may be configured to fully cover an opening of the vehicle body 104 configured to allow ingress and egress to the interior 154 of the vehicle 100 or the one or more door assemblies 152 may be configured to partially cover an opening of the vehicle body 104 configured to allow ingress and egress to the interior 154 of the vehicle 100.

In various examples, the vehicle 100 may further include a charge port 158 configured to be selectively coupled with a vehicle charging source (not shown) to provide charge/recharge to a battery of the vehicle. It will be understood that the vehicle 100 may include a single battery for operating all of the components of the vehicle 100 or may include multiple batteries without departing from the scope of the present disclosure.

As previously introduced, the body 104 of the vehicle 100 may define an interior 154 of the vehicle 100. A floor 162 may be positioned within the interior 154 of the vehicle 100 proximate the chassis 108. A plurality of seating assemblies 166 may be operably coupled with the floor 162 of the vehicle 100 and may be arranged in one or more rows (e.g., a forward row of seating assemblies 166 and a rear row of seating assemblies 166, three rows, or any number of rows as determined by the layout of the vehicle 100).

As best shown in FIG. 2, the vehicle 100 may further include a vehicle dashboard 170 extending across the interior 154 of the vehicle 100 proximate the front portion 112 of the vehicle 100. The dashboard 170 may be configured to house electronics, storage assemblies, a vehicle gauge assembly, and/or other components of the vehicle 100. A steering column 174 may extend from the dashboard 170 proximate a seating assembly 166 and may be coupled with a steering wheel 176. However, it will be understood that the vehicle 100 may be operated using other control systems or features without departing from the scope of the present disclosure.

A center console 180 may be operably coupled with the dashboard 170. The center console 180 may include various components of the vehicle 100 such as, for example, storage compartments, a gear shifter, or additional electronics. In various examples, the center console 180 may be integrally formed with the dashboard 170 as a single component. In other examples, the center console 180 may be separate from the dashboard 170. It is contemplated that the vehicle 100 may not include a center console 180 or may include other components alternatively arranged without departing from the scope of the present disclosure.

Referring still to FIGS. 1 and 2, the body 104 of the vehicle 100 may further define one or more wheel wells 190 each configured to at least partially receive a wheel 194 of the vehicle 100. The wheels 194 of the vehicle 100 may be rotatably coupled with the chassis 108. It will be understood that the wheels 194 may be any type or size of wheel without departing from the scope of the present disclosure.

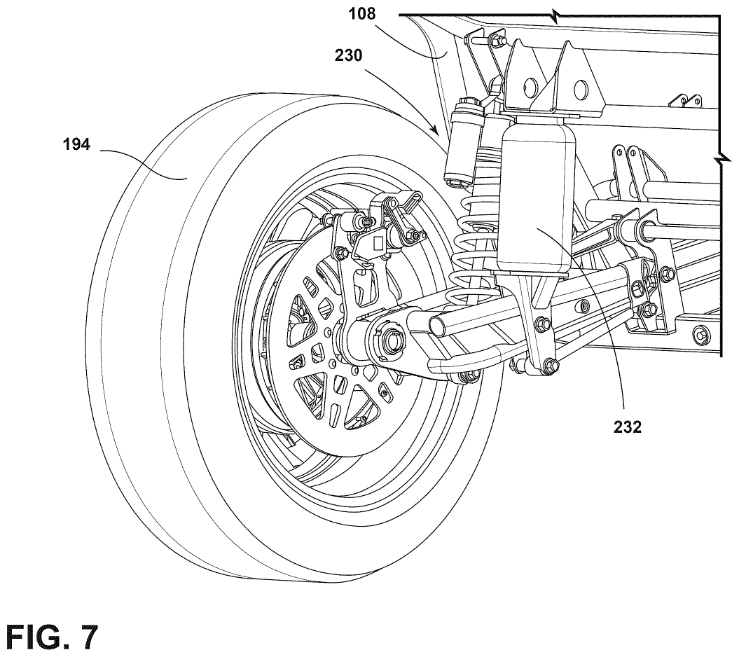

Referring to FIGS. 7-9, the present disclosure relates to a suspension system 230 of the electric vehicle 100 designed to improve ride quality, stability, and handling, while efficiently managing the impact of varying loads. The disclosure may incorporate a flexible suspension system that adapts to different conditions by adjusting the stiffness of one or more helper springs 232 based on real-time measurements of suspension travel or calculated representations of the suspension travel. This adjustment allows the vehicle to respond dynamically to changes in weight distribution or road conditions, enhancing overall driving performance.

In certain optional embodiments, the at least one helper spring 232 may comprise an air spring which works in conjunction with an air compressor coupled to the at least one helper spring 232 using air lines. In other optional embodiments, the at least one helper spring 232 may comprise magnetic ride control (MRC) shocks, electrohydraulic dampers, adaptive or variable coil springs, hydropneumatic springs, electromagnetic springs, magnetorheological dampers, or the like. In further optional embodiments, the at least one helper spring 232 may comprise a progressive rate spring configured to automatically self-adjust in response to changes in vehicle ride height, for example due to vehicle weight or vehicle inclination.

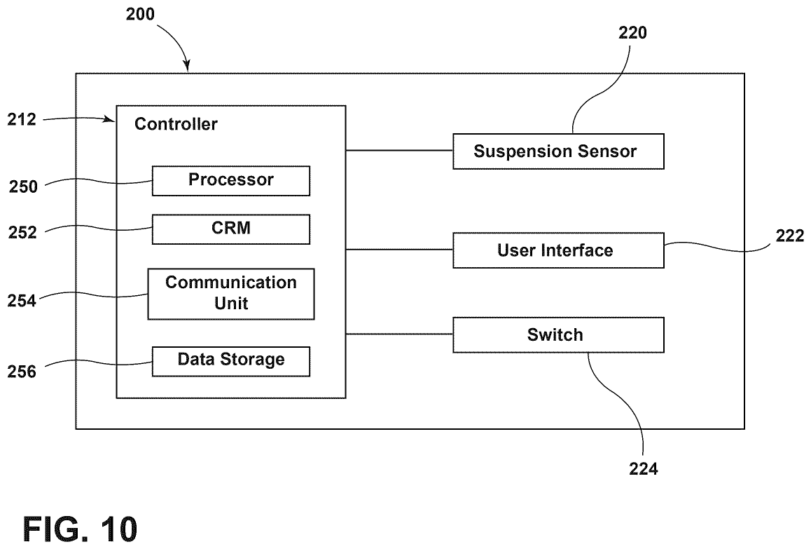

Referring to FIG. 10, the electric vehicle 100 may include a vehicle control system 200. The vehicle control system 200 may include a controller 212 and at least one sensor 220. The at least one sensor 220 may be a distance sensor configured to measure an amount of travel of at least part of the suspension system 230. In certain optional embodiments, the at least one sensor 220 may be a distance sensor configured to measure a vertical distance between one or more of the plurality of wheels 194 and the vehicle body 104 (e.g., an upper edge of the wheel wells 190). In other optional embodiments, the at least one sensor 220 may be a weight sensor configured to measure a weight applied to at least a portion of the suspension system 230. In further optional embodiments, the at least one sensor 220 may be a gyroscope, angular sensor, or one or more or a combination of one or more other sensors configured to measure or calculate an amount of travel of the suspension system 230. The at least one sensor 220 may measure or calculate an angular or other displacement of the suspension system 230. The at least one sensor 220 may be coupled to one or more of the chassis 108, the body 104, or the suspension system 230. In still further optional embodiments, the at least one sensor 220 may comprise a rotary encoder or rotary position sensor configured to measure the angular displacement of a suspension component relative to the vehicle body 104.

The controller 212 may be coupled to both the at least one helper spring 232 and the at least one sensor 220. The controller 212 may process the data from the sensor 220 and may adjust the stiffness of the at least one helper spring 232 accordingly. In some embodiments, a helper spring may be configured to provide additional stiffness to at least a portion of the suspension system 230 of the vehicle 100. By changing the stiffness of the helper spring based on the measured travel or its equivalent, the controller 212 may optimize the suspension system's response to varying loads and may further adjust the suspension system's response to road conditions and driving maneuvers.

The amount of travel measured by the sensor 220 may be associated with the vertical distance between one or more of the vehicle's wheels 194 and the vehicle body 104. This vertical displacement corresponds to the deflection of the suspension system due to the weight or load acting on the vehicle 100, as well as any road-induced forces. In certain optional embodiments, the vehicle 100 may include a gyroscope configured to filter road-induced forces, such that the at least one helper spring 232 may only be engaged in response to a weight or load acting on the vehicle 100.

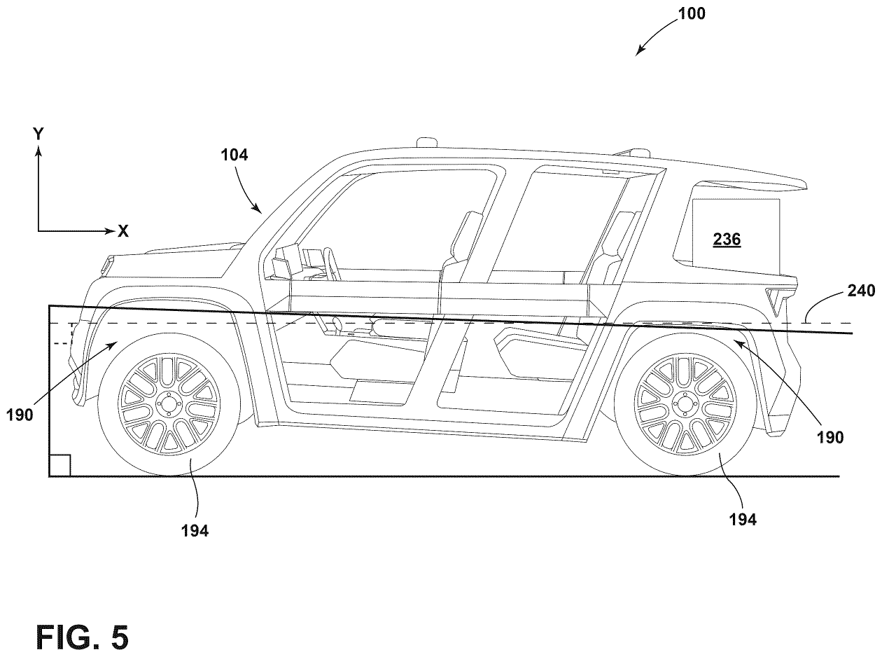

The controller 212 may adjust the stiffness of the at least one helper spring 232 in relation to the measured travel additional weight. In certain optional embodiments, the measured travel may be required to be maintained for a predetermined amount of time (e.g., 1 to 5 second) before the at least one helper spring 232 is engaged. In further optional embodiments, the controller 212 may not adjust the stiffness of the at least one helper spring 232 until the measured travel is greater than or equal to a predetermined threshold amount of travel 240 (as illustrated in FIG. 5).

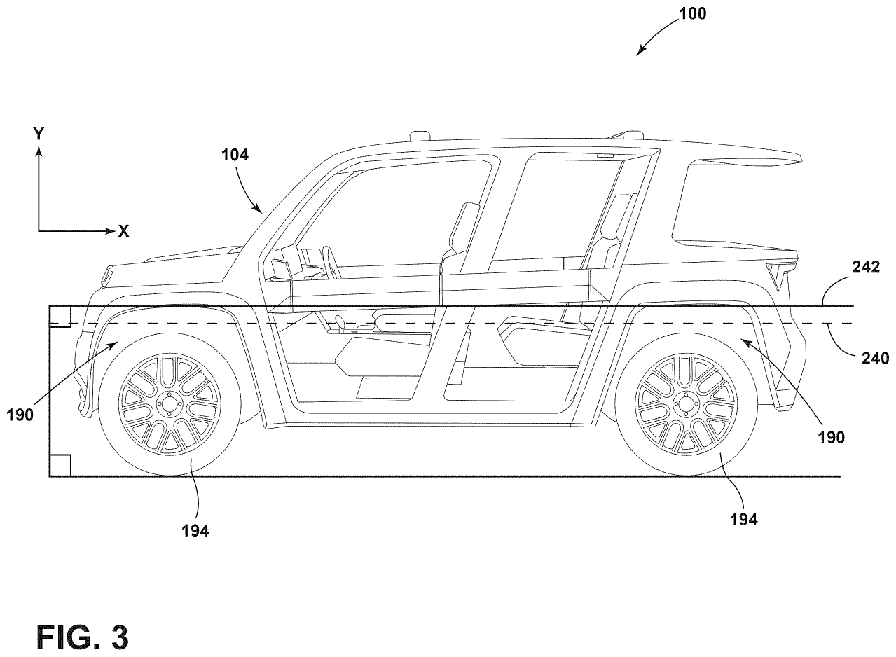

Referring to FIGS. 3-6, X/Y axes are included to help define the height of the front or rear portion of the vehicle 100 from the ground. The height of the vehicle relative to the ground may be determined based on at least part of the body 104 of the vehicle 100 (e.g., its fenders, bumpers, or the like) relative to the ground.

Referring to FIG. 3, the vehicle 100 is shown in an unloaded configuration. The unloaded height of the vehicle 100 may be illustrated by line 242. The unloaded height 242 may also be referred to herein as an unloaded threshold 242. The unloaded threshold 242 may generally be parallel to the X-axis, which is parallel to a ground or support surface of the vehicle 100, as shown. In such instance, the vehicle 100 may be defined as being about level with level being within +/−5 degrees of the X-axis. In certain optional embodiments, “level” may be limited to within +/−4 degrees, +/−3 degrees, +/−2 degrees, or +/−1 degree of the X-axis.

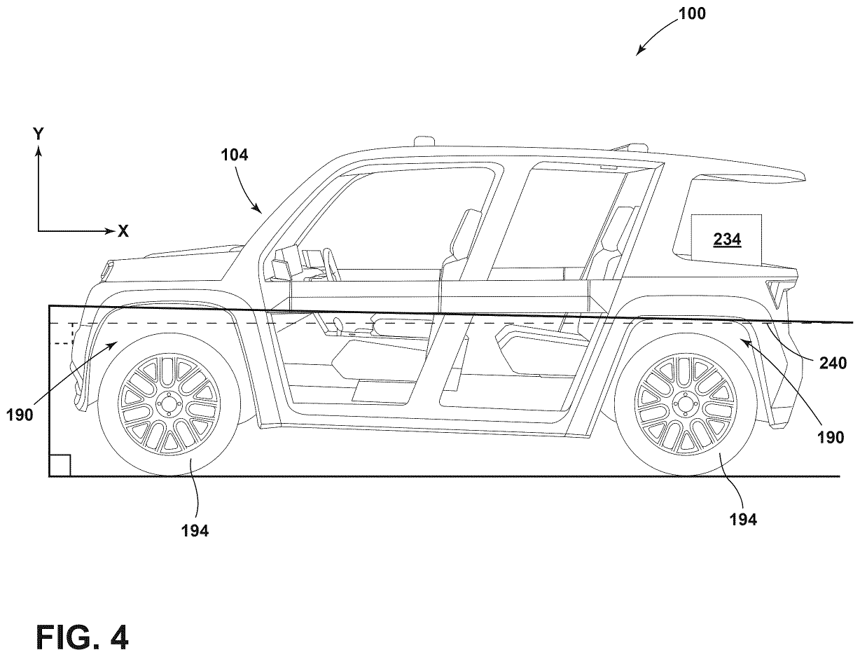

Referring to FIG. 4, the vehicle 100 is shown with a first weight 234 positioned on the rear portion 114 of the vehicle 100. The effect of the first weight 234 may cause a first amount of suspension travel (e.g., in a negative Y-axis direction) that may be less than the predetermined threshold amount of travel 240. As such, the controller 212 may forgo adjusting the stiffness of the at least one helper spring 232. In such a scenario, the at least one helper spring 232 may be maintained at a first stiffness which has little or no effect on the suspension system 230.

Referring to FIG. 5, the vehicle 100 is shown with a second weight 236 positioned on the rear portion 114 of the vehicle 100. The effect of the second weight 236 may cause a second amount of suspension travel (e.g., in a negative Y-axis direction) that may be greater than or equal to the predetermined threshold amount of travel 240. As such, the controller 212 may adjust the stiffness of the at least one helper spring 232 to a second stiffness designed to assist the suspension system 230 to level the vehicle 100 and improve ride quality, stability, and handling. The second amount of travel may be greater than the first amount, indicating that the suspension system is more compressed under heavier loads. The controller 110 can automatically increase or decrease the stiffness of the at least one helper spring 232 to maintain optimal suspension performance and ride quality, even as the weight distribution changes.

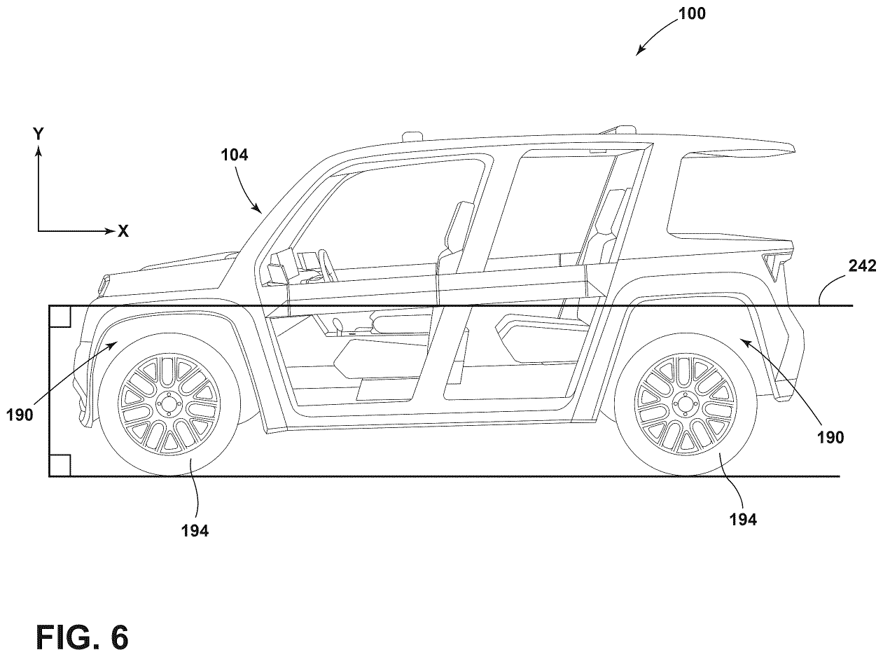

Referring to FIG. 6, the vehicle is shown in an unloaded configuration, except with the at least one helper spring 232 maintained at the second stiffness. As shown, the rear height of the vehicle may be greater than unloaded threshold 242 (e.g., in a positive Y-axis direction). In such a situation, the controller may adjust the stiffness of the at least one helper spring to bring the rear portion of the vehicle 100 back down (e.g., in a negative Y-axis direction) to the unloaded height.

In certain optional embodiments, the controller 212 may compare an amount of suspension travel associated with the front portion 112 of the vehicle 100 with an amount of suspension travel associated with the rear portion 114 of the vehicle 100 to determine a difference in the amount of travel between the front and rear suspension components. In some embodiments, the suspension travel at each portion may be measured using one or more position or displacement sensors, such as linear potentiometers, hall-effect sensors, optical travel sensors, or other suitable suspension-motion sensors operatively coupled to the vehicle's suspension components. The controller 212 may calculate a front-to-rear travel differential, for example, a difference of X, Y, or Z inches of upward or downward travel, where either the front portion 112 may exhibit greater compression relative to the rear portion 114, or vice versa. Based on the detected difference, the controller 212 may adjust the at least one helper spring 232 to compensate for uneven loading conditions. For example, if the front portion 112 is heavily loaded and the rear portion 114 exhibits relatively greater extension, the controller 212 may lower, extend, or increase the preload of the helper spring 232 to assist in leveling the vehicle. Conversely, if the rear portion 114 experiences greater compression (e.g., towing or cargo load conditions), the controller 212 may correspondingly raise, retract, or decrease the preload of the helper spring 232 to restore a desired ride height or pitch balance. In certain embodiments, the system may be configured to accommodate relatively large available ranges of suspension travel, such as approximately 4-6 inches of upward (compression) travel and approximately 2-4 inches of downward (rebound) travel, or other ranges depending on vehicle configuration. The controller 212 may therefore dynamically adjust the helper spring 232 within these travel limits to maintain a substantially level attitude of the vehicle during various operating and loading scenarios.

Referring to FIG. 7, the at least one helper spring 232 may include a helper spring associated with each corner of the vehicle (e.g., each wheel 194). In certain optional embodiments, the at least one helper spring 232 may include first and second helper springs associated with the rear portion 114 of the vehicle (e.g., with each positioned on a different one of the first side or the second side of the vehicle 100). In such an embodiments, the controller 212 may compensate for a lateral weight added to the vehicle by adjusting the stiffness on the first or second side of the vehicle 100 in proportion of the weight affecting each side of the suspension system 230. As such, the stiffness of each helper spring can be matched or different depending on an amount of travel of the suspension system 230.

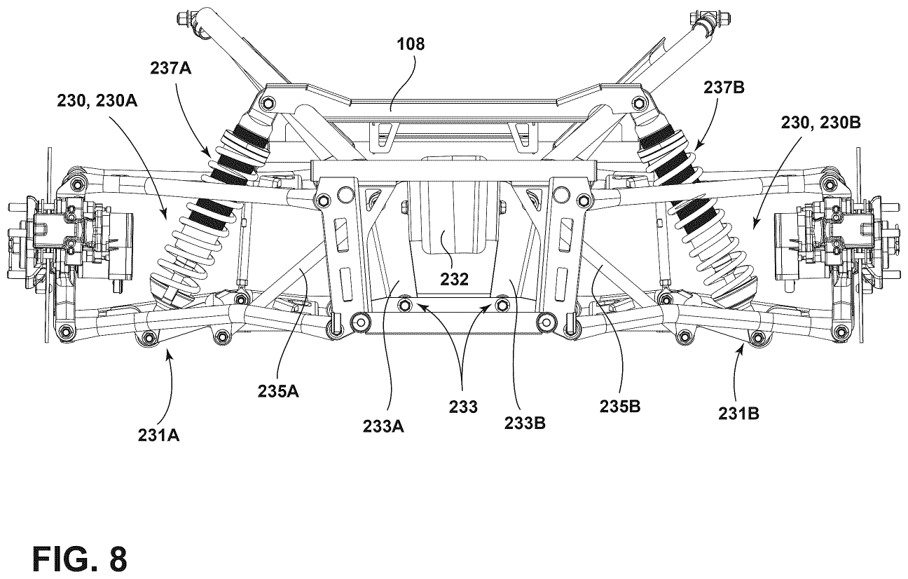

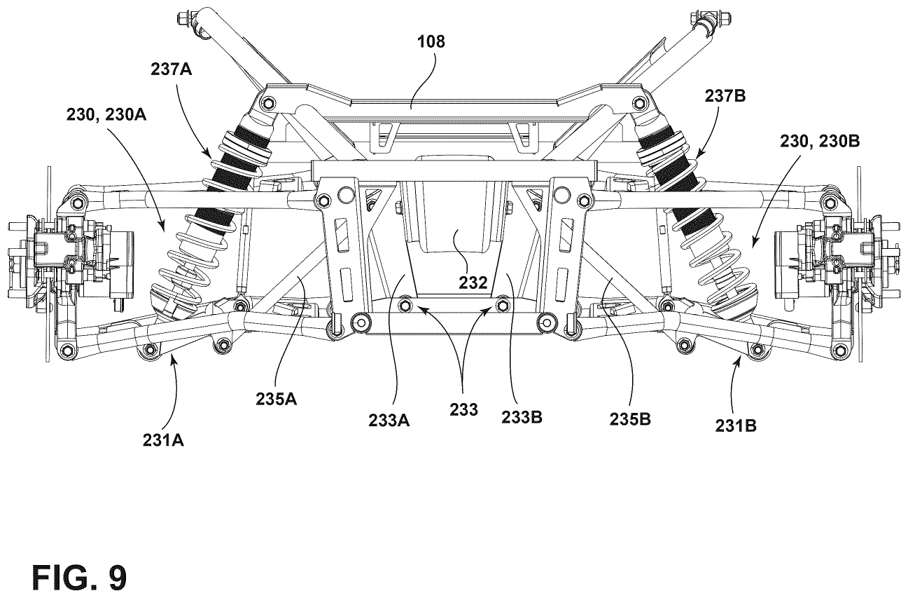

Referring to FIGS. 8 and 9, the at least one helper spring 232 may include only a single helper spring configured to affect the first and second sides 230A, 230B (e.g., the rear portion 114) of the suspension system 230 equally. As illustrated, the single helper spring may be positioned between and coupled to the first side 230A and the second side 230A of the suspension system 230, for example, at respective control arms 231A, 231B. The single helper spring may be supported by a carriage 233 pivotally coupled to the chassis 108 and further coupled to each of the first and second sides 230A, 230B of the suspension system 230, for example using coupling rods 235A, 235B. The carriage 233 may include a first carriage arm 233A and a second carriage arm 233B coupled to the first and second sides 230A, 230B of the suspension system 230 using the coupling rods 235A, 235B. In certain optional embodiments, the carriage may comprise a bell crank style suspension linkage. This configuration allows for more even distribution of the helper spring's force across the suspension system 230, especially when cornering or navigating rough terrain.

The stiffness of the at least one helper spring 232 may be directly proportional to the amount of measured travel. This means that as the suspension system 230 deflects more, the controller 212 may adjust the stiffness of the helper spring to a higher value (e.g., from a first stiffness to a second stiffness), increasing resistance to further compression and thus maintaining vehicle stability. The proportional relationship ensures that the suspension adapts dynamically to changing loads. As illustrated in FIG. 8, the at least one helper spring 232 may have a first stiffness associated with the first weight 234. As illustrated in FIG. 9, the at least one helper spring 232 may have a second stiffness associated with the second weight 236, which reduces tension on the main suspension components 237A, 237B associated with the first and second sides 230A, 230B of the suspension system 230, thus raising the associated portion of the vehicle 100. The main suspension components 237A, 237B may comprise shock absorbers, such as coilover shock absorbers, mono-tube shock absorbers, twin-tube shock absorbers, or the like.

In certain optional embodiments, adjustment of the stiffness of the at least one helper spring 232 may additionally influence the effective damping characteristics of the suspension system 230. For example, as the helper spring 232 is stiffened in response to increased suspension travel, the resulting increase in reaction force may reduce oscillation amplitude following large impacts or rapid weight shifts. Conversely, when the controller 212 reduces the stiffness of the helper spring 232, such as during low-speed operation or when minimal load is detected, the suspension system 230 may exhibit a softer, more compliant response. This dynamic interaction between spring stiffness and overall suspension behavior may allow the vehicle 100 to maintain a desired ride height and ride quality under varying loads, speeds, and terrain conditions.

In other optional embodiments, the controller 212 may adjust the stiffness of the at least one helper spring 232 not only based on instantaneous suspension travel but also based on predictive or anticipatory operating conditions. For example, the controller 212 may receive input from additional vehicle sensors, such as accelerometers, gyroscopes, angular sensors, steering-angle sensors, throttle-position sensors, or GPS modules, to anticipate upcoming maneuvers such as cornering, acceleration, deceleration, or changes in grade. Based on these inputs, the controller 212 may pre-load or partially increase the stiffness of the helper spring 232 to reduce sudden chassis pitch or roll. Such anticipatory adjustment may improve vehicle stability by preparing the suspension system 230 for transient loads before they occur.

In certain optional embodiments, the controller 212 may regulate adjustment of the helper spring stiffness within predetermined maximum and minimum values to prevent over-compression or excessive rebound of the suspension system 230. For example, when the helper spring 232 reaches an upper stiffness threshold, the controller 212 may inhibit further stiffening to avoid overstressing the helper spring or associated linkages. Conversely, as the suspension system 230 approaches full extension, the controller 212 may reduce the helper-spring contribution toward a minimum (e.g., by bleeding pressure from an air spring or opening a bypass in an electrohydraulic unit), optionally maintaining only a small anti-rattle preload to preserve component engagement and avoid topping-out. In some embodiments, a hysteresis strategy may be used so that helper-spring contribution is disabled above an extension threshold and is only re-enabled after travel returns within a nominal range. These limits and strategies may provide predictable suspension behavior and maintain structural integrity during extreme or rapidly changing driving conditions.

In certain other optional embodiments, the relationship between the measured suspension travel and the stiffness of the at least one helper spring 232 may be governed by a control algorithm executed by the controller 212. For example, the controller 212 may employ a proportional-only control law in which the stiffness increases linearly with the measured amount of travel. In other embodiments, a proportional-integral-derivative (PID) control algorithm may be used to provide smoother responses and avoid oscillation during rapid changes in suspension travel. In still other embodiments, the controller 212 may select stiffness values from a set of discrete predetermined levels (e.g., low, medium, high, or maximum) based on corresponding ranges of measured travel. These algorithmic approaches may enable tuning of the suspension system 230 for different vehicle platforms, payload capacities, or desired ride characteristics.

In further optional embodiments, the controller 212 may support a manual override mode or one or more driver-selectable ride modes. For example, the vehicle 100 may include settings such as “Comfort,” “Sport,” or “Load/Tow,” each corresponding to predefined stiffness ranges for the at least one helper spring 232. In such embodiments, the controller 212 may continue to adjust stiffness dynamically within the selected mode based on measured suspension travel while maintaining the general ride characteristics associated with the chosen setting. This configuration may allow the operator to tailor the vehicle's suspension behavior to personal preference or anticipated driving conditions while still benefiting from automatic leveling functionality.

In certain optional embodiments, the electric vehicle 100 may include a user interface 222 that may be coupled to the controller 212, allowing the vehicle operator to manually adjust the stiffness of the suspension system 230. The user interface may include a switch 224 or other control mechanisms that provide a signal indicative of the position of the switch 224. Based on this signal, the controller 212 may modify the stiffness of the one or more of at least one helper spring 232 to the desired level, enabling the driver to tailor the suspension response based on personal preference or specific driving conditions.

In other optional embodiments, the controller 212 may include a memory and a processing unit, further described below, that store instructions and execute them to automatically adjust the stiffness of the one or more of the at least one helper spring 232 based on the measured amount of suspension travel. This automatic adjustment ensures that the suspension system 230 continuously responds to the vehicle's load and the current driving conditions without requiring manual input from the driver.

The controller 212 further includes or may be associated with a processor 250, a computer readable medium 252, and data storage 256 such as for example a database network. It may be understood that the controller 212 described herein may be a single controller having some or all of the described functionality, or it may include multiple controllers wherein some or all of the described functionality is distributed among the multiple controllers.

Various operations, steps or algorithms as described in connection with the controller 212 can be embodied directly in hardware, in a computer program product such as a software module executed by the processor 250, or in a combination of the two. The computer program product can reside in RAM memory, flash memory, ROM memory, EPROM memory, EEPROM memory, registers, hard disk, a removable disk, or any other form of computer-readable medium 252 known in the art. An exemplary computer-readable medium 252 can be coupled to the processor 250 such that the processor 250 can read information from, and write information to, the memory/storage medium 252. In the alternative, the medium 252 can be integral to the processor 250. The processor 250 and the medium 252 can reside in an application specific integrated circuit (ASIC). The ASIC can reside in a user terminal. In the alternative, the processor 250 and the medium 252 can reside as discrete components in a user terminal.

The term “processor” 250 as used herein may refer to at least general-purpose or specific-purpose processing devices and/or logic as may be understood by one of skill in the art, including but not limited to a microprocessor, a microcontroller, a state machine, and the like. A processor 250 can also be implemented as a combination of computing devices, e.g., a combination of a DSP and a microprocessor, a plurality of microprocessors, one or more microprocessors in conjunction with a DSP core, or any other such configuration.

The communication unit 254 may support or provide communications between the controller 212 and external communications units, systems, or devices, and/or support or provide communication interface with respect to internal components of the electric vehicle 100. The communications unit may include wireless communication system components (e.g., via cellular modem, WiFi, Bluetooth or the like) and/or may include one or more wired communications terminals such as universal serial bus ports.

The data storage 256, unless otherwise stated, generally encompass hardware such as volatile or non-volatile storage devices, drives, electronic memory, and optical or other storage media, as well as in certain embodiments one or more databases residing thereon.

The present disclosure further relates to a method for dynamically adjusting the at least one helper spring 232 of the suspension system 230 to optimize ride quality, stability, and handling performance. The method involves continuously monitoring the suspension system's behavior and adjusting the stiffness of the at least one helper spring 232 based on real-time data from a sensor that measures suspension travel. This allows the vehicle to adapt to changing loads, ensuring a more responsive and comfortable driving experience.

The method begins by determining the amount of travel of the vehicle's suspension system 230 using at least one sensor 220. The sensor 220, which may be positioned to measure the vertical displacement between the vehicle's wheels and its body, provides real-time data that reflects how much the suspension system 230 has deflected due to additional weight. This data may then be used to determine whether the stiffness of the at least one helper spring 232 needs to be adjusted. If the amount of travel exceeds a predetermined threshold, indicating that the suspension system may be experiencing a significant load or deflection, the stiffness state of the at least one helper spring 232 may be adjusted to provide enhanced support.

The primary input for the method may be the amount of travel measured by the at least one sensor 220. This sensor 220 may monitor the deflection of the suspension system 230, which correlates with the vertical distance between the vehicle's wheels 194 and its body 104. The amount of travel indicates how much the suspension is compressed or extended due to various forces acting on the vehicle 100, such as weight distribution.

In one embodiment, the sensor may measure the suspension travel continuously or at periodic intervals, providing the controller with real-time data about the suspension's behavior. This allows the controller 212 to respond dynamically to changing conditions, ensuring the vehicle maintains optimal ride quality and stability.

Once the amount of travel is determined and compared against the predetermined threshold, the stiffness of the at least one helper spring 232 may be adjusted accordingly. If the travel is greater than the threshold, indicating an increased load or force acting on the suspension, the controller 212 activates an adjustment mechanism to modify the stiffness state of the at least one helper spring 232.

The stiffness adjustment may be based on different amounts of travel corresponding to different weights added to the vehicle 100. For example, a first stiffness may be associated with a first amount of travel sensed by the sensor 220, which corresponds to a first weight added to the vehicle 100. Similarly, a second stiffness may be associated with a second amount of travel, which corresponds to a second, potentially larger, weight added to the vehicle 100. By adjusting the stiffness of the at least one helper spring 232, the suspension system 230 can adapt to varying loads, mitigating the effects of heavier or lighter loads, leveling the vehicle 100, and providing a more controlled ride.

One goal of adjusting the stiffness of the at least one helper spring 232 may be to mitigate excessive deflection of the suspension system 230 or the vehicle body 104. When additional weight is added to the vehicle 100, such as passengers, cargo, or equipment, the suspension system 230 may compress further. This may result in undesirable body roll, reduced stability, and compromised handling performance. By adjusting the stiffness of the at least one helper spring 232, the method helps control the suspension deflection and ensures that the vehicle 100 remains stable and comfortable under varying loads.

The adjustment helps to maintain the ride height, improving both handling performance and comfort. For instance, when heavy loads are detected, the stiffness can be increased to prevent the vehicle from sagging, ensuring the suspension system 230 can adequately support the added weight without compromising vehicle dynamics.

The stiffness adjustment of the at least one helper spring 232 may be triggered in two ways, depending on the design and preference of the vehicle owner, specifically manually or automatically. The stiffness adjustment can be manually initiated by the driver. This may involve a user interface 222, such as a switch 224, dial, or touchscreen control, which allows the driver to adjust the stiffness of the at least one helper spring 232 according to their preference. The stiffness adjustment can be controlled automatically by a controller 212. In this case, the controller uses data from the sensor 220 to continuously monitor the amount of travel in the suspension system 230 and adjust the helper spring stiffness accordingly. This automatic system ensures that the vehicle's suspension may always be optimized for current driving conditions, eliminating the need for manual intervention and providing a seamless driving experience.

The automatic control system can be implemented through a feedback loop, where the sensor's real-time data may be processed by a controller 212 that sends commands to adjust the stiffness of the at least one helper spring 232. This could be done by applying a current/voltage to an electromagnetically adjustable shock or spring, or using electronic actuators, motors, solenoids, valves, or other mechanisms that adjust the spring's properties to suit the vehicle's load and suspension behavior.

This method of dynamically adjusting the stiffness of the suspension helper spring provides several advantages over traditional, fixed-stiffness suspension systems. By continuously monitoring the suspension's travel and adjusting the stiffness in response to real-time conditions, the vehicle can maintain optimal ride quality, stability, and comfort in a wide range of scenarios, from light loads to fully loaded conditions.

The method also allows for improved handling and safety, as the system can react to changes in load or driving conditions without the driver needing to make manual adjustments. Whether the vehicle is carrying a heavy or light load, the suspension system may adapt to provide a smoother and more controlled ride.

Furthermore, this method may be highly flexible, allowing for both manual and automatic control options, giving the driver or the vehicle's onboard system the ability to adjust the suspension stiffness to suit their preferences or needs.

Although exemplary embodiments are described in connection with lightweight electric vehicles, the load leveling systems described herein may be applied to various types of vehicles including internal combustion vehicles, hybrid vehicles, on-road vehicles, off-road vehicles, or specialized equipment where adaptive suspension performance is desirable.

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in” and “on.” The phrase “in one embodiment,” as used herein does not necessarily refer to the same embodiment, although it may.

It will be understood by those of skill in the art that information and signals may be represented using any of a variety of different technologies and techniques (e.g., data, instructions, commands, information, signals, bits, symbols, and chips may be represented by voltages, currents, electromagnetic waves, magnetic fields or particles, optical fields or particles, or any combination thereof). Likewise, the various illustrative logical blocks, modules, circuits, and algorithm steps described herein may be implemented as electronic hardware, computer software, or combinations of both, depending on the application and functionality. Moreover, the various logical blocks, modules, and circuits described herein may be implemented or performed with a general purpose processor (e.g., microprocessor, conventional processor, controller, microcontroller, state machine or combination of computing devices), a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. Similarly, steps of a method or process described herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art.

Although embodiments of the present disclosure have been described in detail, it will be understood by those skilled in the art that various modifications can be made therein without departing from the spirit and scope of the disclosure as set forth in the appended claims.

A controller, computing device, or computer, such as described herein, includes at least one or more processors or processing units and a system memory. The controller may also include at least some form of computer readable media. By way of example and not limitation, computer readable media may include computer storage media and communication media. Computer readable storage media may include volatile and nonvolatile, removable and non-removable media implemented in any method or technology that enables storage of information, such as computer readable instructions, data structures, program modules, or other data. Communication media may embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It will be understood that the particular embodiments described herein are shown by way of illustration and not as limitations of the disclosure. The principal features of this disclosure may be employed in various embodiments without departing from the scope of the disclosure. Those of ordinary skill in the art will recognize numerous equivalents to the specific procedures described herein. Such equivalents are considered to be within the scope of this disclosure and are covered by the claims.

All of the compositions and/or methods disclosed and claimed herein may be made and/or executed without undue experimentation in light of the present disclosure. While the compositions and methods of this disclosure have been described in terms of the embodiments included herein, it will be apparent to those of ordinary skill in the art that variations may be applied to the compositions and/or methods and in the steps or in the sequence of steps of the method described herein without departing from the concept, spirit, and scope of the disclosure. All such similar substitutes and modifications apparent to those skilled in the art are deemed to be within the spirit, scope, and concept of the disclosure as defined by the appended claims.

The previous detailed description has been provided for the purposes of illustration and description. Thus, although there have been described particular embodiments of a new and useful invention, it is not intended that such references be construed as limitations upon the scope of this disclosure except as set forth in the following claims.

What is claimed is:

1. An electric vehicle comprising:
a chassis;
a suspension system coupled to the chassis;
at least one helper spring coupled to and configured to selectively assist the suspension system;
at least one sensor configured to measure an amount of travel of at least part of the suspension system; and
a controller coupled to the at least one helper spring and the at least one sensor, the controller configured to control a stiffness of the at least one helper spring based on the measured amount of travel of the at least part of the suspension system.

2. The electric vehicle of claim 1, wherein:
the amount of travel of the suspension system is associated with a vertical distance between one or more of a plurality of wheels of the electric vehicle and a vehicle body of the electric vehicle.

3. The electric vehicle of claim 1, wherein:
the at least one helper spring is configured to provide a first stiffness, wherein the first stiffness is associated with a first amount of travel measured by the at least one sensor, and the first amount of travel is associated with a first weight acting on the electric vehicle; and
the at least one helper spring is configured to provide a second stiffness, wherein the second stiffness is associated with a second amount of travel measured by the at least one sensor, and the second amount of travel is associated with a second weight acting on the electric vehicle.

4. The electric vehicle of claim 3, wherein:
the second amount of travel distance is greater than the first amount of travel.

5. The electric vehicle of claim 3, wherein:
the first amount of travel is less than a predetermined threshold amount of travel.

6. The electric vehicle of claim 5, wherein:
the second amount of travel is greater than or equal to the predetermined threshold amount of travel.

7. The electric vehicle of claim 1, wherein:
the at least one helper spring includes a first helper spring and a second helper spring.

8. The electric vehicle of claim 7, wherein:
an unloaded stiffness of each of the first helper spring and the second helper spring is matched.

9. The electric vehicle of claim 7, wherein:
an unloaded stiffness of each of the first helper spring and the second helper spring is different.

10. The electric vehicle of claim 7, wherein:
the first helper spring is associated with a forward portion of the suspension system and the second helper spring is associated with a rearward portion of the suspension system.

11. The electric vehicle of claim 1, wherein:
an amount of stiffness of the at least one helper spring is proportional to the measured amount of travel.

12. The electric vehicle of claim 1, further comprising a user interface coupled to the controller, wherein the user interface comprises a switch configured to provide a signal to the controller indicative of a position of the switch, and wherein the controller changes the stiffness of the at least one helper spring based on the signal indicative of the position of the switch.

13. The electric vehicle of claim 1, wherein the controller further comprises:
a memory having instructions stored thereon;
a processing unit coupled to the memory, wherein the processing unit executes the instructions to:
automatically adjust the stiffness of the at least one helper spring based on the measured amount of travel of the suspension system.

14. The electric vehicle of claim 1, wherein:
the suspension system includes a first side portion associated with a first wheel of the electric vehicle and a second side portion associated with a second wheel of the electric vehicle.

15. The electric vehicle of claim 14, wherein:
the at least one helper spring includes a first helper spring associated with the first side portion of the suspension system and a second helper spring associated with the second side portion of the suspension system.

16. The electric vehicle of claim 14, wherein:
the at least one helper spring comprises a single helper spring positioned between and coupled to the first side portion and the second side portion of the suspension system.

17. The electric vehicle of claim 16, wherein:
the single helper spring is supported by a carriage coupled to each of the first side portion and the second side portion of the suspension system.

18. The electric vehicle of claim 1, wherein when a vehicle body of the electric vehicle is higher than an unloaded threshold, the stiffness of the at least one helper spring is reduced.

19. A method of dynamically adjusting a suspension helper spring of an electric vehicle having a chassis and a main suspension system coupled to the chassis, the method comprising:
determining an amount of travel of the main suspension system using at least one sensor; and
adjusting a stiffness state of at least one suspension helper spring when the amount of travel is greater than a predetermined threshold amount of travel.

20. The method of claim 19, further comprising:
providing a first stiffness is associated with a first amount of travel sensed by the at least one sensor, the first amount of traveling being associated with a first weight added to the electric vehicle; and
providing a second stiffness is associated with a second amount of travel sensed by the at least one sensor, the second amount of traveling being associated with a second weight added to the electric vehicle.
